(19) United States
(12) Patent Application Publication
(10) Pub. No.: US 2013/0024769 A1
(43) Pub. Date: Jan. 24, 2013

(54) APPARATUS AND METHOD FOR PROCESSING A DOCUMENT

(71) Applicants: Atsushi Sumida, Chiba (JP); Masahiro Takehi, Tokyo (JP)

(72) Inventors: Atsushi Sumida, Chiba (JP); Masahiro Takehi, Tokyo (JP)

(73) Assignee: INTERNATIONAL BUSINESS MACHINES CORPORATION, Armonk, NY (US)

(21) Appl. No.: 13/467,140

(22) Filed: May 9, 2012

(30) Foreign Application Priority Data
Jul. 21, 2011 (JP) 2011-160307

(51) Int. Cl. G06F 17/00

(52) U.S. Cl. 715/255

(57) ABSTRACT

An authentication certificate server receives an acquisition request of a confidential document which specifies a URI of a disclosable document obtained by removing a confidential element from the confidential document, the authentication certificate server transmits an acquisition request of the disclosable document to a public server and specifies a dictionary file based on the URI, and if the user has an access authority to the confidential element, the authentication certificate server transmits an acquisition request of a dictionary file to a confidential server. When the authentication certificate server receives the dictionary file from the confidential server and receives the disclosable document from the public server, the authentication certificate server restores the confidential document by returning the confidential element at a position in the disclosable document which position is specified by the dictionary file, and then transmits the confidential document thus restored to the terminal device.

### FIELD OF THE INVENTION

The present invention relates to an apparatus and a method for processing a document. Particularly, the present invention relates to an apparatus and a method for processing a processed document obtained by performing, on an original document, a process of removing an information element constituting part of the original document.

### BACKGROUND ART

Along with the spread of cloud services, the depositing of structural outlines of confidential documents to a service of a third party becomes more general. As for the cloud services, security thereof is a matter of concern. However, if it is possible to reduce risks in “depositing” of a confidential document, it is possible to use cloud services more flexibly, which raises the possibility that the advantage of any cost cutting in IT, which is the advantage of the cloud services, can be enjoyed.

Here, such a technique has been known that a confidential portion of a confidential document is made illegible if there is a possibility that the confidential document may be publicly exposed (for example, see Japanese Unexamined Patent Publication No. 2007-65778, Japanese Unexamined Patent Publication No. 2009-188808, and Japanese Unexamined Patent Publication No. 2006-99491.

In the technique of Japanese Unexamined Patent Publication No. 2007-65778, a mark indicative of an information acquisition level input by a person who discloses information is compared with marks indicative of confidentiality importance levels given to pieces of confidential information recorded in a confidential information dictionary. All pieces of confidential information with marks having confidentiality importance levels higher than the mark indicative of the information acquisition level are extracted, and character strings in the entire document corresponding to the extracted pieces of confidential information are all replaced randomly with unique character strings in the confidential information dictionary.

In a technique of Japanese Unexamined Patent Publication No. 2009-188808, specific information to specify a confidential portion of input image data is detected from the input image data, the confidential portion specified by the specific information thus detected is modified to generate output data, and the output data thus generated is output.

In a technique of Japanese Unexamined Patent Publication No. 2006-99491, an encrypted data file obtained by encrypting a data file specified from a client terminal by use of an encryption key corresponding to the client terminal is transmitted to the client terminal, and when it is judged that the client terminal is an authenticated destination of the encrypted data file, a decryption key is transmitted to the client terminal.

### SUMMARY OF THE INVENTION

If a technique to make such a confidential portion illegible is used, it is possible to reduce risks in the “depositing” of a confidential document.

However, when a confidential document is deposited by using a cloud service, it is necessary to remove a confidential portion from the confidential document and deposit this confidential portion to the cloud service, so that the confidential document can be restored by using the confidential portion when requested.

In the techniques of Patent Japanese Unexamined Patent Publication No. 2007-65778 and Japanese Unexamined Patent Publication No. 2009-188808, a confidential portion is just made illegible, and restoration of the confidential portion thus made illegible into an original state is not performed. Further, in the technique of Japanese Unexamined Patent Publication No. 2006-99491, the encryption of critical information is a process of making the critical information illegible unless a decode key is used. However, the encryption is a process of leaving the critical information in the same place. Thus, it cannot be said that the technique premises a process of removing critical information from a confidential document.

In view of this, the above-described prior art techniques do not provide a technique for restoring a confidential document when a confidential portion is removed from the confidential document. In other words, conventionally, in a case where a document is stored by removing an element constituting a part thereof, the document cannot be restored.

The present invention makes it possible to restore a document when the document is stored by removing an element constituting part of the document.

The present invention provides an apparatus for processing a processed document obtained by performing, on an original document, a removal of an information element constituting part of the original document, which apparatus includes: a first acquisition section for acquiring the processed document from a first storage in which the processed document is stored; a second acquisition section for acquiring the information element from a second storage in which the information element is stored; and a restoration section for restoring the original document by adding the information element acquired by the second acquisition section to a position which is predefined as a position where the information element is to be added in the processed document thus acquired by the first acquisition section.

Here, in this apparatus, in a case where the processing is to replace the information element with a dummy element for covering a meaning of the information element, the restoration section may use a position of that dummy element in the processed document which is to be replaced with the information element, as a position where the information element is to be added in the processed document.

Further, in this apparatus, the second acquisition section may acquire the information element by acquiring definition information which defines a position where the information element is to be added in the processed document, from the second storage in which the information element is stored in such a manner that the information element is included in the definition information.

Furthermore, in this apparatus, the second acquisition section may acquire the information element from a storing location which is associated with a storing location of the processed document beforehand.

Moreover, in this apparatus, the second acquisition section may acquire the information element from a storing location described in the processed document acquired by the first acquisition section.

Further, in this apparatus, the second acquisition section may acquire the information element in a case where information indicating that a user who requests the restoration of the original document is allowed to use the information element is registered.

Furthermore, this apparatus may further include: a receiving section for receiving the original document and position information indicative of a position of the information element in the original document; a processing section for performing, on the original document received by the receiving section, a removal of the information element at a position indicated by the position information received by the receiving section; and a transmitting section for transmitting the processed document generated by the processing by the processing section to the first storage and for transmitting the information element thus removed by the processing by the processing section to the second storage.

Further, the present invention provides an apparatus for processing a processed document obtained by performing, on an original document, a replacement of a confidential element constituting part of the original document with a dummy element that reduces confidentiality of the confidential element, which apparatus includes: a first acquisition section for acquiring the processed document from a first storage in which the processed document is stored; a detecting section for detecting, based on first location information indicative of a location of the first storage, second location information indicative of a location of a second storage in which definition information is stored which defines a position of the dummy element to be replaced with the confidential element when the original document is restored; a second acquisition section for acquiring the definition information from the second storage placed at the location indicated by the second location information detected by the detecting section; and a restoration section for restoring the original document by replacing with the confidential element the dummy element in the processed document acquired by the first acquisition section, which dummy element is placed at the position defined by the definition information acquired by the second acquisition section.

Further, the present invention provides an apparatus for processing a processed document obtained by performing, on an original document, a replacement of a confidential element constituting part of the original document with a dummy element that reduces confidentiality of the confidential element, which apparatus includes: a first acquisition section for acquiring the processed document from a first storage in which the processed document is stored; a detecting section for detecting, based on a content described in the processed document acquired by the first acquisition section, location information indicative of a location of a second storage in which definition information is stored which defines a position of the dummy element to be replaced with the confidential element when the original document is restored; a second acquisition section for acquiring the definition information from the second storage placed at the location indicated by the location information detected by the detecting section; and a restoration section for restoring the original document by replacing with the confidential element the dummy element in the processed document acquired by the first acquisition section, which dummy element is placed at the position defined by the definition information acquired by the second acquisition section.

Further, the present invention provides a method for processing a processed document obtained by performing, on an original document, a removal of an information element constituting part of the original document, which method includes: acquiring the processed document from a first storage in which the processed document is stored; acquiring the information element from a second storage in which the information element is stored; and restoring the original document by adding the information element thus acquired to a position which is predefined as a position where the information element is to be added in the processed document thus acquired.

Furthermore, the present invention provides a program for causing a computer to function as an apparatus for processing a processed document obtained by performing, on an original document, a removal of an information element constituting part of the original document, the program causing the computer to function as: a first acquisition section for acquiring the processed document from a first storage in which the processed document is stored; a second acquisition section for acquiring the information element from a second storage in which the information element is stored; and a restoration section for restoring the original document by adding the information element acquired by the second acquisition section to a position which is predefined as a position where the information element is to be added in the processed document acquired by the first acquisition section.

According to the present invention, it is possible to restore a document when the document is stored by removing an element constituting part of the document.

### BRIEF DESCRIPTION OF THE DRAWINGS

FIG. 1 illustrates an exemplary configuration of a cloud service system to which an embodiment of the present invention is applied.

FIG. 2 illustrates an example of an outline of an operation of a cloud service system to which an embodiment of the present invention is applied.

FIG. 3 illustrates another example of an outline of an operation of a cloud service system to which an embodiment of the present invention is applied.

FIG. 4 is a sequence diagram which exemplifies exchanges of information between a terminal device, an authentication certificate server, a public server, and a confidential server in an embodiment of the present invention.

FIG. 5 is a block diagram illustrating an exemplary configuration of a function of the authentication certificate server in an embodiment of the present invention.

FIG. 6 illustrates an example of a stored content of an authentication information storage section of an authentication certificate server in an embodiment of the present invention.

FIG. 7 illustrates an example of a stored content of an access-control information storage section of an authentication certificate server in an embodiment of the present invention.

FIG. 8 illustrates an example of a stored content of a dictionary information storage section of the authentication certificate server in an embodiment of the present invention.

FIG. 9 is a flowchart illustrating an exemplary operation at the time of confidential-document registration by the authentication certificate server in an embodiment of the present invention.

FIG. 10 is a flowchart illustrating an exemplary operation at the time of confidential-document acquisition by the authentication certificate server in an embodiment of the present invention.

FIG. 11 is a sequence diagram which exemplifies exchanges of information between a terminal device, an authentication certificate server, a public server, and a confidential server in an embodiment of the present invention.

FIG. 12 is a block diagram illustrating an exemplary configuration of a function of the authentication certificate server in an embodiment of the present invention.

FIG. 13 is a view illustrating one example of a disclosable document to be acquired by the authentication certificate server in an embodiment of the present invention.

FIG. 14 is a flowchart illustrating an exemplary operation at the time of confidential-document registration by the authentication certificate server in an embodiment of the present invention.

FIG. 15 is a flowchart illustrating an exemplary operation at the time of confidential-document acquisition by the authentication certificate server in an embodiment of the present invention.

FIG. 16 is a view illustrating a hardware configuration of a computer to which an embodiment of the present invention is applicable.

### DETAILED DESCRIPTION OF THE INVENTION

Hereinafter, with reference to attached drawings, embodiments of the present invention are described in detail.

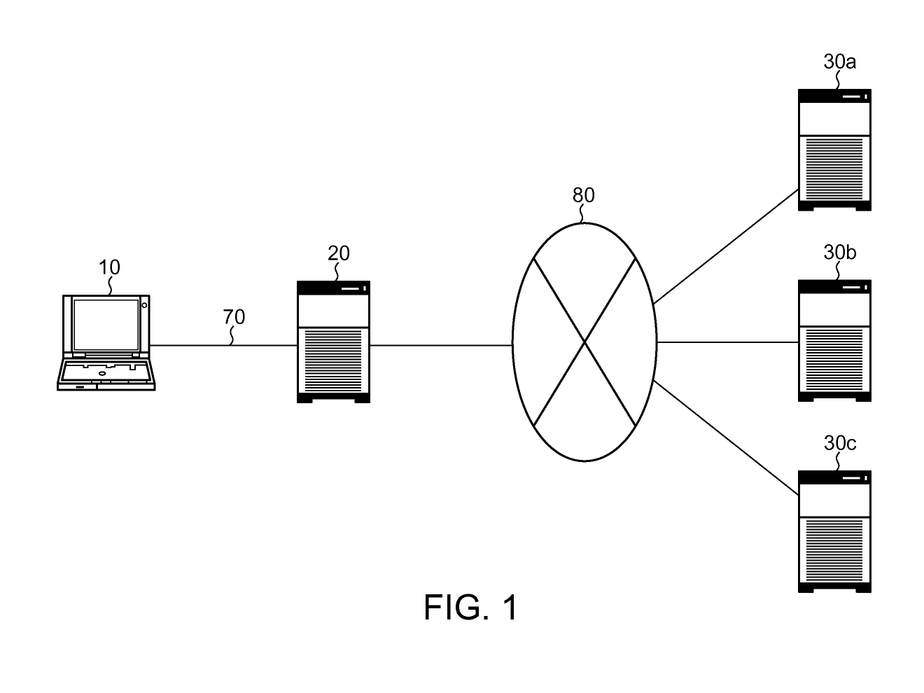

FIG. 1 is a block diagram illustrating an exemplary configuration of a cloud service system in accordance with an embodiment.

As illustrated in FIG. 1, the cloud service system includes a terminal device 10, an authentication certificate server 20, and cloud servers 30a, 30b, and 30c. The terminal device 10 is connected to the authentication certificate server 20 through a network 70, and the authentication certificate server 20 is connected to the cloud servers 30a, 30b, and 30c through a network 80. Note that FIG. 1 illustrates the cloud servers 30a, 30b, and 30c, but when it is not necessary to distinguish them, they may be referred to as a cloud server 30. Further, FIG. 1 illustrates three cloud servers 30, but the number of cloud servers 30 is not limited to this and may be two, or four or more.

The terminal device 10 is a computer device used by a user who receives the provision of a cloud service. For example, as the terminal device 10, a PC (Personal Computer) may be used. Further, it is assumed that a web browser (hereinafter just referred to as a “browser”) is installed in the terminal device 10.

The authentication certificate server 20 is a reverse-proxy server computer for implementing Single Sign-On and an access control to the cloud servers 30a, 30b, and 30c. As the authentication certificate server 20, a PC (Personal Computer), a workstation, and the like computers may be used, for example.

The cloud server 30 is a server computer for providing a cloud service. Generally, the cloud service means a service which provides a resource without making a user aware of where the resource is provided on a network, and for example, the cloud service includes services which provide an application program, an OS (Operating System), and the like as resources. However, the cloud service herein particularly indicates a service which proves a storage on the network as a resource to keep data of a user therein. As the cloud server 30, a PC (Personal Computer), a workstation, and the like computers may be used, for example.

Here, a level of confidentiality (confidentiality level) of a confidential document to be deposited in the cloud server 30 changes depending on contents of confidential elements constituting part of the confidential document and a combination thereof, and the risk to leakage of the confidential document also changes in conjunction with this. For example, the confidentiality level of a fictitious confidential document that “a new product New Product is going to be shipped on 2010/12/15” decreases by performing a process (masking) of hiding some part thereof such that “a new product %words02% is going to be shipped on 20%words01%.” The two character strings on which masking is performed as such are separately managed (accessed and used) by defining them such that “%words01%=10/12/15” and “%words02=New Product,” so that the leakage risk is reduced as a whole, thereby promoting the use of the cloud service and the like.

However, if this structure is used for a general-purpose confidential document management, a structure of access management to a document from which confidential elements are removed and the confidential elements thus removed is complicated, which will be a burden when the structure is actually developed as a solution.

In view of this, an embodiment of the invention proposes a system in which with the use of the reverse-proxy authentication certificate server 20, a structure which reduces the risk of information leakage by masking of a confidential element is fused with an existing technology to be utilized. That is, the structure is fused with a structure of a web-based access management system which has been already established, so that information protection by masking is performed effectively to be developed to a cloud environment.

For example, there are various cloud services such as one used universally, one used in specific business communities, and one used in a specific company, and their forms and security levels are different. In a case where data is deposited, the one used universally can be used at a low charge, but its service targets many users, and thus a concern about security risk is large. Further, in contrast, if users who can use a service are limited, the concern about security risk is small, but the charge for the service is high. In a case where pieces of data are stored in a single cloud server 30, those problems pose a dilemma. In order to solve such a dilemma, in an embodiment, pieces of data are stored in a plurality of cloud servers 30. More specifically, one confidential document is divided into portions, and a portion with a low confidentiality level is deposited in a cloud server 30 with a low security level while a portion with a high confidentiality level is deposited in a cloud server 30 with a high security level. With such a structure, appropriate information management is realized.

However, in order to realize such a structure, it is important how to unify those portions of the confidential document which are deposited in different cloud servers 30 at the time of utilization so as to utilize them effectively.

The reverse-proxy authentication certificate server 20 has a function to authenticate and certify access to a web resource. In view of this, in an embodiment, the access to cloud servers 30 storing portions of a confidential document is managed by use of this function of the authentication certificate server 20.

Further, some authentication certificate servers 20 can process passing data via an API (Application Program Interface). In view of this, in an embodiment, divided portions of a confidential document are unified via the API and supplied to the terminal device 10.

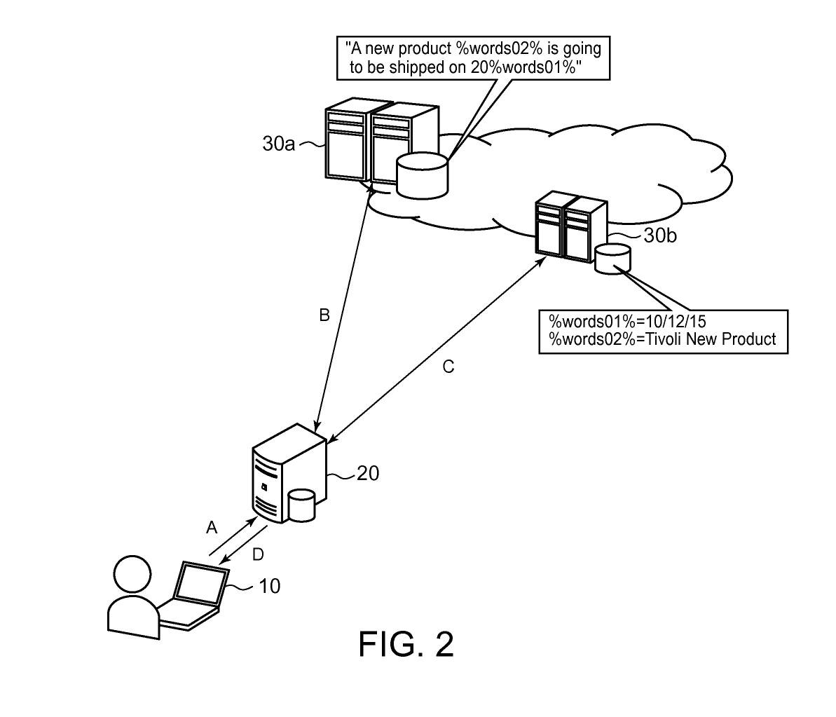

FIG. 2 is a view illustrating an outline of a system which realizes such a structure. Herein, among the cloud servers 30a, 30b, and 30c in FIG. 1, the cloud server 30a is assumed as a public server 30a for storing a disclosable document as an example of a processed document obtained by removing confidential elements from a confidential document to lower its confidentiality level so that the document is disclosable. Further, the cloud server 30b is assumed as a confidential server 30b for storing a confidential element as an example of an information element separated from a confidential document to increase a confidentiality level of a disclosable document. Note that a disclosable document and a confidential element are stored in separate cloud servers 30 here, but they may be stored in separate storages of a single cloud server 30. That is, the public server 30a is one example of a first storage in which to store a processed document, and the confidential server 30b is an example of a second storage in which to store an information element or definition information.

The operation of this system is briefly described below.

First, when a user inputs authentication information (e.g., a user ID and a password), the terminal device 10 is connected to the authentication certificate server 20 by use of the authentication information, and when the user requests a disclosable document stored in the public server 30a, the terminal device 10 transmits the request to the authentication certificate server 20 (A). Subsequently, the authentication certificate server 20 transmits the request to the public server 30a, and in response to this, the public server 30a returns the disclosable document to the authentication certificate server 20 (B). In the meantime, the authentication certificate server 20 transmits a request of confidential elements corresponding to the disclosable document to the confidential server 30b, and in response to this, the confidential server 30b returns the confidential elements to the authentication certificate server 20 (C). Here, for example, the public server 30a holds a disclosable document that “a new product %words02% is going to be shipped on 20%words01,” and when a user requests this disclosable document, this disclosable document is returned to the authentication certificate server 20. In the meantime, the confidential server 30b holds confidential elements “%words01%=10/12/15” and “%words02%=New Product” corresponding to the disclosable document, and when the user requests this disclosable document, these confidential elements are returned to the authentication certificate server 20. After that, the authentication certificate server 20 unifies the disclosable document and the confidential elements thus returned by an external program via an API to restore an original confidential document, and supplies the confidential document thus restored to the terminal device 10 (D).

That is, according to such a structure, the user can obtain a significant document which is restored by the authentication certificate server 20 by fusing portions of a confidential document which have been divided and stored separately and which have different confidentiality levels.

Further, in order to separate confidential elements from an original confidential document, it is conceivable that, when the confidential document is deposited in a cloud service, a process of automatically separating a word considered to be confidential is performed by a dictionary function implemented beforehand. However, a word defined in the dictionary function is not necessarily a highly confidential word, and it is often judged that a confidential element has a high confidentiality level according to a context (a context of a sentence). That is, there is such a case where a word that is usually not considered to be confidential may be a word that should be handled with as confidential in a certain context, or such an adverse case where a word that is usually considered to be confidential may not be confidential in a certain context.

Accordingly, an embodiment of the invention provides such a function that, when a user performs, on a browser, an operation of selecting words or phrases to be confidential elements from text data which should be stored in a cloud service, they are replaced with masking character strings such as “words01%” and “%words02%,” and a document (a disclosable document) in which such words or phrases are replaced is registered in the public server 30a, while such words or phrases to be confidential elements are registered in the confidential server 30b. This function serves as a function included in contents displayed by the browser, and therefore is provided in a rich client which is implemented by Ajax (Asynchronous JavaScript (registered trademark)+XML), Flash (registered trademark), or the like. Further, the separation of confidential elements may be performed by using a technique implemented by a comment function or the like of general word processor software. More specifically, a function to select a character string in text data when a comment is given by word processor software and to associate the comment with the character string may be applied to a function to select a character string in text data and to replace the character string with a masking character string such as “%words01%” or “%words02%.” The confidential elements thus separated are registered in the confidential server 30b by the application of the terminal device 10 which application is implemented by Ajax, Flash (registered trademark), or the like. Here, the masking character string is a character string which is irrelevant to a confidential element so as to reduce a confidential level of the confidential element, and is an example of a dummy element.

Further, when the confidential elements are registered in the confidential server 30b as such, the authentication certificate server 20 also registers access-control information corresponding to these confidential elements, thereby starting information protection based on this access-control information.

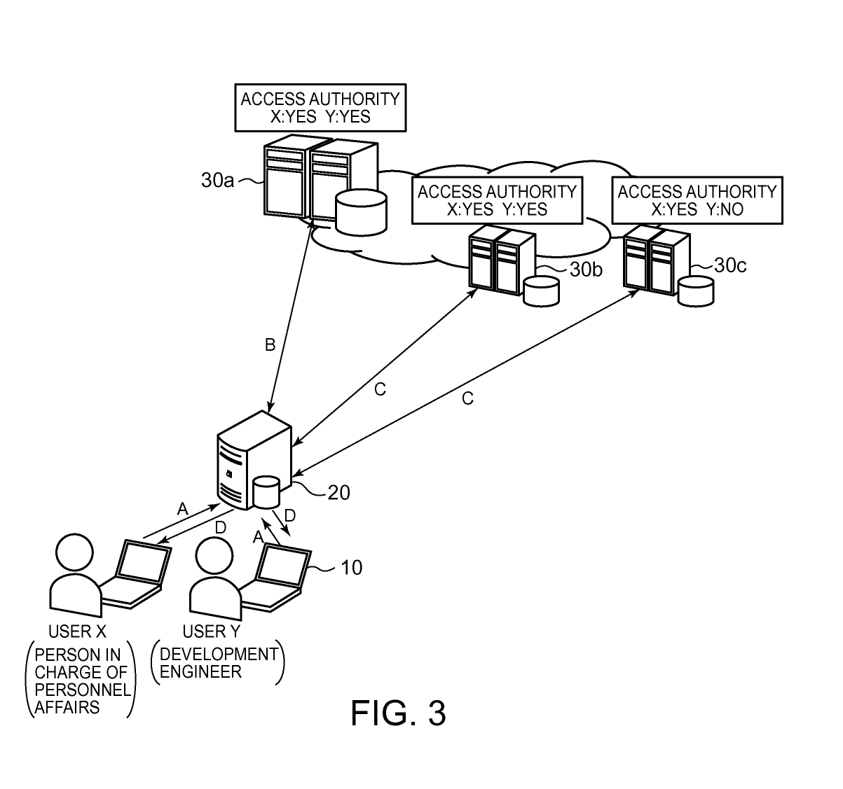

FIG. 3 is a view illustrating an outline of a system obtained by adding a function to control the access to confidential elements according to an attribute of a user to the system of FIG. 2. Herein, among the cloud servers 30a, 30b, and 30c in FIG. 1, the cloud server 30a is assumed as a public server 30a for storing a disclosable document. Further, the cloud server 30b is assumed as an intermediate confidential server 30b for storing a confidential element with an intermediate confidentiality level, and the cloud server 30c is assumed as a high confidential server 30c for storing a confidential element with a high confidentiality level. Further, a user X has an attribute of a person in charge of personnel affairs and a user Y has an attribute of a development engineer, and both the person in charge of personnel affairs and the development engineer can access the confidential element with an intermediate confidentiality level, but only the person in charge of personnel affairs can access the confidential element with a high confidentiality level.

The operation of this system is the same as FIG. 2 in terms of A and B. On the other hand, in terms of C, a request of a confidential element corresponding to a disclosable document is transmitted to the intermediate confidential server 30b or the high confidential server 30c. It is then verified whether or not a user has an authority of access to the intermediate confidential server 30b or the high confidential server 30c. For example, in a case where the confidential element corresponding to the disclosable document which is requested in B is stored in the intermediate confidential server 30b, even if whichever of the user X and the user Y requests, the confidential element is returned from the intermediate confidential server 30b (C). Subsequently, the authentication certificate server 20 unifies the disclosable document and the confidential element thus returned by an external program via an API to restore an original confidential document, and supplies the confidential document thus restored to the terminal device 10 (D). In the meantime, in a case where the confidential element corresponding to the disclosable document requested in B is stored in the high confidential server 30c, if the user X requests, the confidential element is returned from the high confidential server 30c, but if the user Y requests, the confidential element is not returned from the high confidential server 30c (C). Subsequently, if the confidential element is returned, the authentication certificate server 20 unifies the disclosable document and the confidential element thus returned and supplies the original confidential document to the terminal device 10, but if the confidential element is not returned, the authentication certificate server 20 supplies the disclosable document thus returned to the terminal device 10 as it is (D).

Note that the systems illustrated in FIG. 2 and FIG. 3 can be applied to a service to sell an added value element with the use of an element (hereinafter referred to as an “added value element”) to give some sort of added value to a disclosable document, instead of a confidential element.

For example, in FIG. 3, it is assumed that the public server 30a discloses a document in which masking is performed on an added value element, the intermediate confidential server 30b is assumed as an intermediate value server 30b for storing an added value element having an intermediate value, and the high confidential server 30c is assumed as a high value server 30c for storing an added value element having a high value. In this system, in B, a document in which masking is performed on an added value element is returned from the public server 30a and displayed once on a browser of the terminal device 10. Then, when a user presses down a “subscription application” button on the document, the authentication certificate server 20 requests the added value element to the intermediate value server 30b or the high value server 30c in C. Hereby, the added value element is returned from the intermediate value server 30b or the high value server 30c to the authentication certificate server 20, and the authentication certificate server 20 sends the added value element to the terminal device 10. Thus, the user can obtain the added value element by paying for it to a company providing the document. Note that, in this service, the intermediate value server 30b stores an added value element having an intermediate value and the high value server 30c stores an added value element having a high value. Accordingly, the price of the added value element stored in the high value server 30c may be set higher than the price of the added value element stored in the intermediate value server 30b.

The following describes the configuration and operation of such a cloud service system in detail. Note that, in the following description, it is assumed that a public server 30a and a single confidential server 30b are provided as the cloud servers 30, for convenience of explanation.

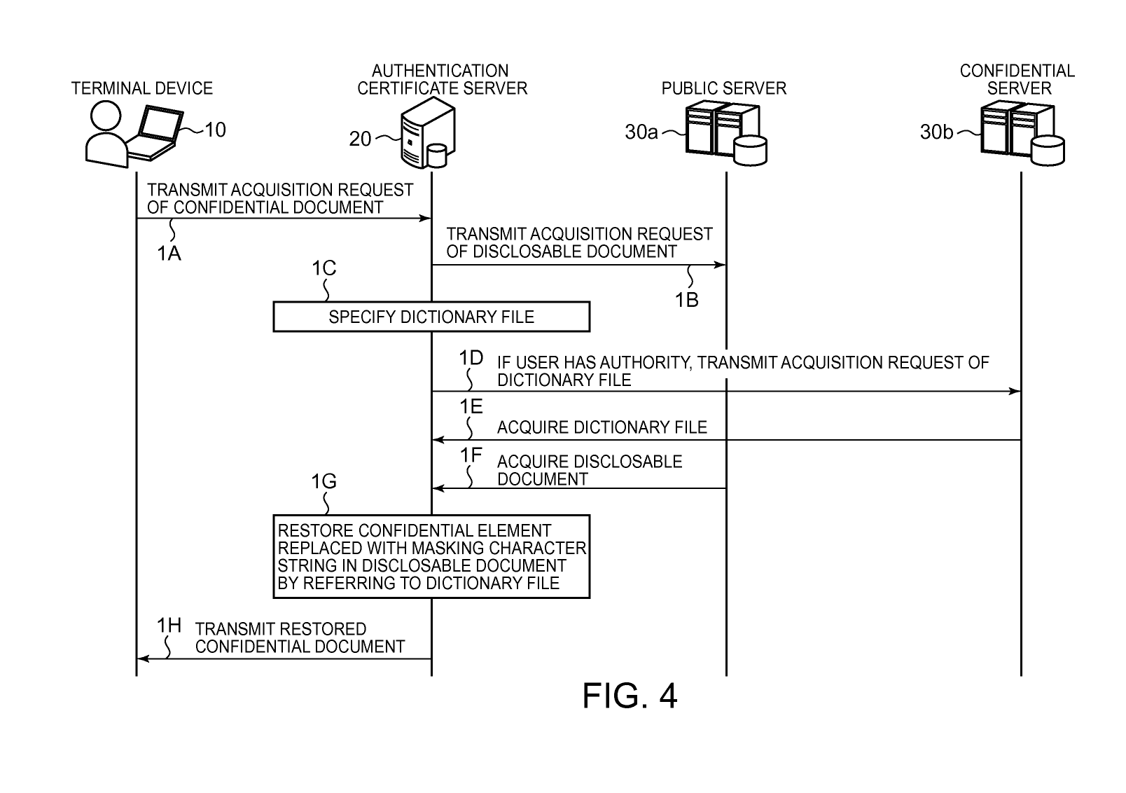

FIG. 4 is a sequence diagram illustrating exchanges of information between a terminal device 10, an authentication certificate server 20, a public server 30a, and a confidential server 30b in a case of specifying a confidential element corresponding to a disclosable document based on a URI (Uniform Resource Identifier) of the disclosable document. Note that it is assumed that, in advance of the exchanges of information in FIG. 4, the authentication of a user in the authentication certificate server 20 is completed.

Initially, when a user specifies, as a request URI, a URI of a disclosable document obtained by masking a confidential document and requests acquisition of the confidential document, the terminal device 10 transmits the acquisition request of the confidential document including the request URI to the authentication certificate server 20 (1A).

Subsequently, the authentication certificate server 20 checks on a request content, and transmits an acquisition request of the disclosable document to the public server 30a (1B).

In the meantime, the authentication certificate server 20 specifies a dictionary file based on the request URI received in 1A (1C). Here, a dictionary file is a file which defines which masked portion in a disclosable document should be replaced with which confidential element, and the dictionary file is an example of definition information. This definition element is stored in the confidential server 30b.

Further, the authentication certificate server 20 checks whether or not the user has an authority of access to this dictionary file, and if the user has the authority, the authentication certificate server 20 transmits an acquisition request of the dictionary file to the confidential server 30b (1 D).

Hereby, the confidential server 30b transmits the dictionary file, and the authentication certificate server 20 acquires this dictionary file (1 E).

Further, in response to the acquisition request of the disclosable document transmitted in 1B, the public server 30a transmits the disclosable document, and the authentication certificate server 20 acquires this disclosable document (1 F).

Subsequently, the authentication certificate server 20 replaces a masked portion in the disclosable document acquired in 1F with a confidential element by referring to the dictionary file acquired in 1E to restore an original confidential document (1G).

Then, the authentication certificate server 20 transmits the original confidential document thus restored to the terminal device 10 (1H).

The following describes the configuration of the authentication certificate server 20 in an embodiment in detail.

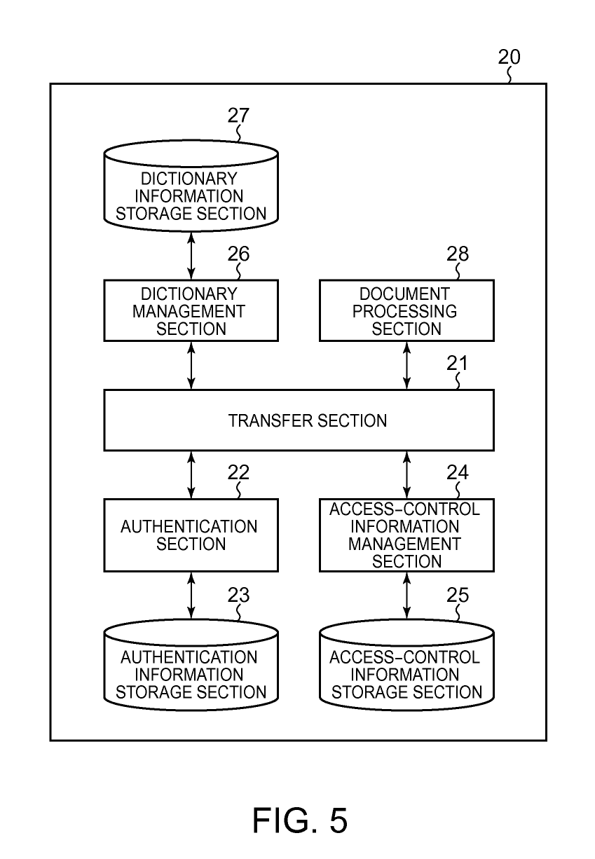

FIG. 5 is a block diagram illustrating an exemplary configuration of a function of the authentication certification server 20 in an embodiment.

As illustrated in FIG. 5, the authentication certificate server 20 includes a transfer section 21, an authentication section 22, an authentication information storage section 23, an access-control information management section 24, an access-control information storage section 25, a dictionary management section 26, a dictionary information storage section 27, and a document processing section 28.

The transfer section 21 transfers information sent from the terminal device 10 to the public server 30a or the confidential server 30b, and transfers information sent from the public server 30a or the confidential server 30b to the terminal device 10. Further, the transfer section 21 supplies information to the authentication section 22, the access-control information management section 24, the dictionary management section 26, and the document processing section 28 so that these sections perform respective processes. In an embodiment, the transfer section 21 is provided as an example of the following sections: a receiving section for receiving an original document and location information; a transmitting section for transmitting a processed document and an information element; a first acquisition section for acquiring the processed document; and a second acquisition section for acquiring the information element or definition information.

In a case where the authentication section 22 receives a user ID of the user and a password from the transfer section 21, the authentication section 22 refers to its own-device authentication information stored in the authentication information storage section 23 so as to perform authentication of whether or not the user may use the authentication certificate server 20, and acquires attribute information of the user to return a result to the transfer section 21. Further, in a case where the authentication section 22 receives, from the transfer section 21, a user ID and information to specify a public server 30a, the authentication section 22 refers to public-server authentication information stored in the authentication information storage section 23 so as to acquire a user ID and a password to use the specified public server 30a, and returns them to the transfer section 21. Further, in a case where the authentication section 22 receives, from the transfer section 21, a user ID and information to specify a confidential server 30b, the authentication section 22 refers to confidential-server authentication information stored in the authentication information storage section 23 so as to acquire a user ID and a password to use the specified confidential server 30b, and returns them to the transfer section 21.

The authentication information storage section 23 stores the own-device authentication information, the public-server authentication information, and the confidential-server authentication information which are referred to by the authentication section 22. Note that these pieces of authentication information will be described later in detail.

In a case where the access-control information management section 24 receives, from the transfer section 21, information indicative of whether or not a user having given attribute information can access a dictionary file specified by given dictionary location information and dictionary file information, the access-control information management section 24 registers, in access-control information stored in the access-control information storage section 25, the attribute information, the dictionary location information, the dictionary file information, and accessibility information indicative of whether the access is allowed or not. Further, in a case where the access-control information management section 24 receives, from the transfer section 21, attribute information, dictionary location information, and dictionary file information, the access-control information management section 24 refers to accessibility information of access-control information stored in the access-control information storage section 25, and judges whether or not a user having the attribute information may access a dictionary file specified by the dictionary location information and the dictionary file information.

The access-control information storage section 25 stores access- control information that is updated and referred to by the access-control information management section 24. Note that this access-control information will be described later in detail.

In a case where the dictionary management section 26 receives, from the transfer section 21, document location information indicative of a storing location of a disclosable document, and dictionary location information and dictionary file information to specify a dictionary file by which a masking character string of this disclosable document is replaced with a confidential element, the dictionary management section 26 registers a corresponding relation between them in dictionary information stored in the dictionary information storage section 27. Further, in a case where the dictionary management section 26 receives, from the transfer section 21, document location information indicative of a storing location of a disclosable document, the dictionary management section 26 refers to dictionary information stored in the dictionary information storage section 27, and retrieves a dictionary file used for replacing, with a confidential element, a masking character string in the disclosable document stored in the storing location indicated by the document location information. Note that, the function of this dictionary management section 26 may be implemented, for example, by executing an external program via the API. In an embodiment, document location information is used as an example of first location information indicative of a first storage location, and dictionary location information is used as an example of second location information indicative of a second storage location. Further, the dictionary management section 26 is provided as an example of a detecting section for detecting the second location information based on the first location information.

The dictionary information storage section 27 stores dictionary information that is updated and referred to by the dictionary management section 26. Note that this dictionary information will be described later in detail.

In a case where the document processing section 28 receives, from the transfer section 21, a confidential document and position information indicative of a position of a confidential element in the confidential document, the document processing section 28 generates a disclosable document by removing a confidential element at a position indicated by the position information from the confidential documents. Further, in a case where the document processing section 28 receives a disclosable document and a dictionary file from the transfer section 21, the document processing section 28 restores an original confidential document by replacing a masked portion in the disclosable document with a confidential element defined in the dictionary file. Note that, the function of this document processing section 28 may be implemented, for example, by executing an external program via the API. In an embodiment, the document processing section 28 is provided as an example of: a processing section for performing, on an original document, processing of removing an information element; and a restoration section for restoring the original document.

Here, the own-device authentication information, the public-server authentication information, and the confidential-server authentication information which are stored in the authentication information storage section 23 are described in detail.

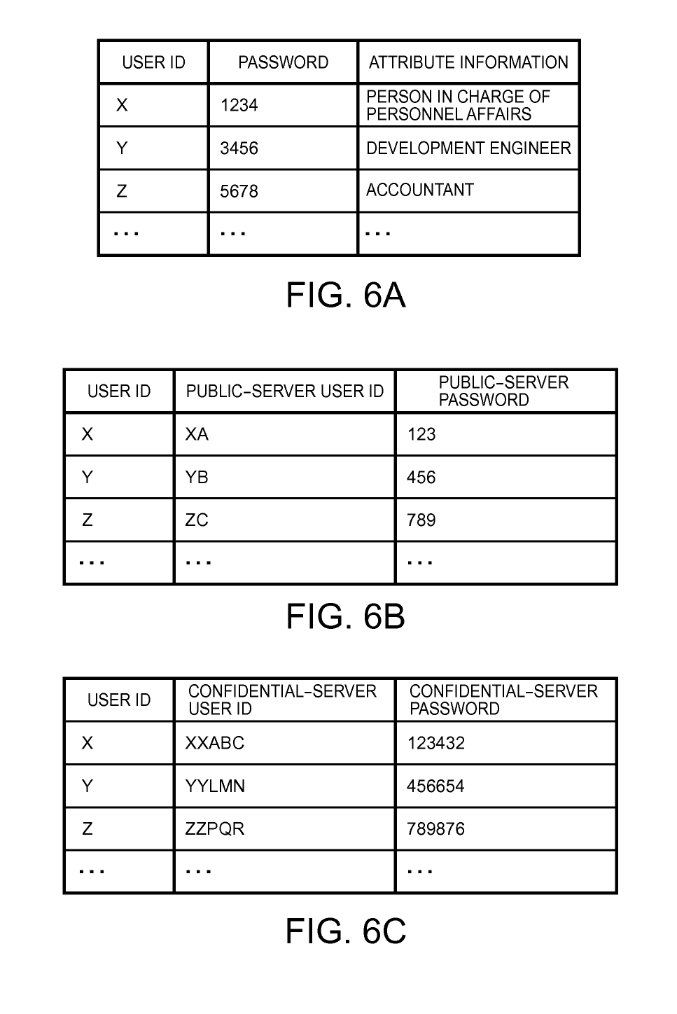

FIG. 6A is a view illustrating an example of the own-device authentication information.

As illustrated in FIG. 6A, the own-device authentication information is information in which a user ID, a password, and attribute information are associated with each other.

The user ID is a number or the like to identify a user, among pieces of information that the user inputs to use the authentication certificate server 20. Note that in order to use the public server 30a and the confidential server 30b, user IDs which are different from the above user ID are necessary. However, when the term “user ID” is just used in the present specification, it refers to the user ID for the authentication certificate server 20.

Among the pieces of information that the user inputs to use the authentication certificate server 20, the password is letters, numbers, a combination thereof, and the like to check that the user is an authenticated person. Note that in order to use the public server 30a and the confidential server 30b, other passwords that are different from the above password is necessary. However, when the term “password” is just used in the present specification, it refers to the password for the authentication certificate server 20.

The attribute information is information indicative of an attribute of the user, and is, for example, information of a department that the user belongs to or a post of the user.

FIG. 6B is a view illustrating an example of the public-server authentication information.

As illustrated in FIG. 6B, the public-server authentication information is information in which a user ID, a public-server user ID, and a public- server password are associated with each other.

As has been already described, the user ID is a number or the like to identify the user, among the pieces of information that the user inputs to use the authentication certificate server 20.

The public-server user ID is a number or the like to identify the user, among pieces of information that the user inputs to use the public server 30a.

The public-server password is letters, numbers, a combination thereof, or the like to check that the user is an authenticated person, among the pieces of information that the user inputs to use the public server 30a.

Note that, if there are a plurality of public servers, as many pieces of public-server authentication information as the number of public servers are provided.

FIG. 6C is a view illustrating an example of the confidential-server authentication information.

As illustrated in FIG. 6C, the confidential-server authentication information is information in which a user ID, a confidential-server user ID, and a confidential-server password are associated with each other.

As has been already described, the user ID is a number or the like to identify the user, among the pieces of information that the user inputs to use the authentication certificate server 20.

The confidential-server user ID is a number or the like to identify the user among pieces of information that the user inputs to use the confidential server 30b.

The confidential-server password includes letters, numbers, a combination thereof, or the like, to check that the user is an authenticated person, among the pieces of information that the user inputs to use the confidential server 30b.

Note that, if there are a plurality of confidential servers, as many pieces of confidential-server authentication information as the number of confidential servers are provided.

Further, the following describes the access-control information stored in the access-control information storage section 25 in detail.

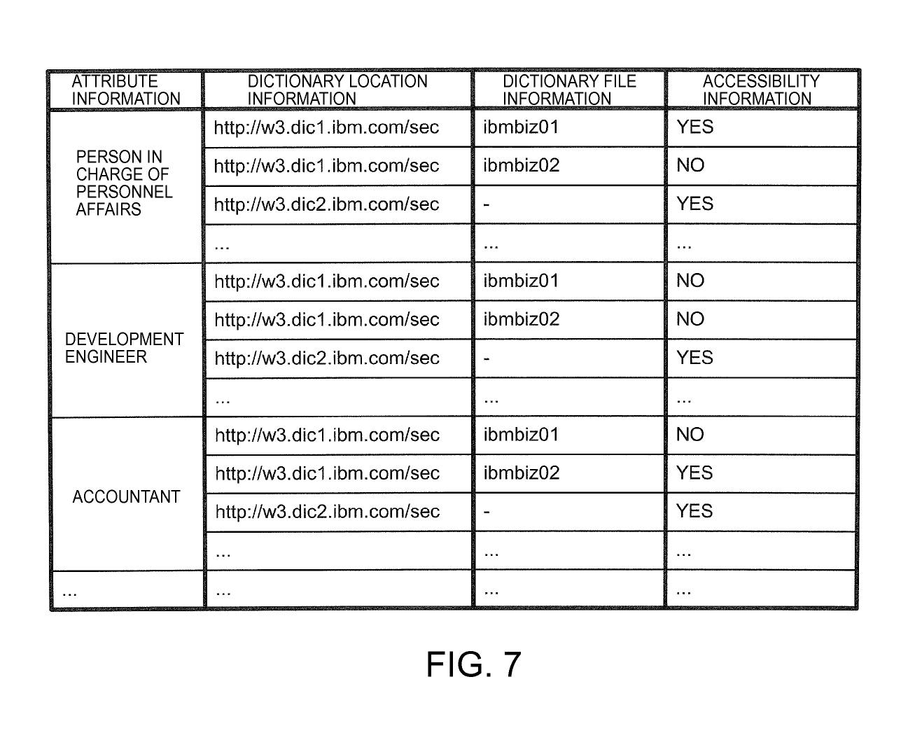

FIG. 7 is a view illustrating an example of the access-control information.

As illustrated in FIG. 7, the access-control information is information in which attribute information, dictionary location information, dictionary file information, and accessibility information are associated with each other.

As has been already described, the attribute information is information indicative of the attribute of the user.

The dictionary location information is information indicative of a location on a network where a dictionary file by which a masked portion of a disclosable document is replaced with a confidential element is stored, and specifies, for example, a character string constituted by a scheme, a host name, and a portion of a pass except for a dictionary file name.

The dictionary file information is information to specify a dictionary file at that location on the network which is indicated by the dictionary location information, and specifies, for example, a dictionary file name.

The accessibility information is information indicative of whether or not a user having an attribute indicated by corresponding attribute information can access a dictionary file specified by corresponding dictionary location information and dictionary file information. In the figure, “YES” indicates one who is allowed to access a corresponding dictionary file, and “NO” indicates one who is not allowed to access a corresponding dictionary file.

Further, the following describes dictionary information stored in the dictionary information storage section in detail.

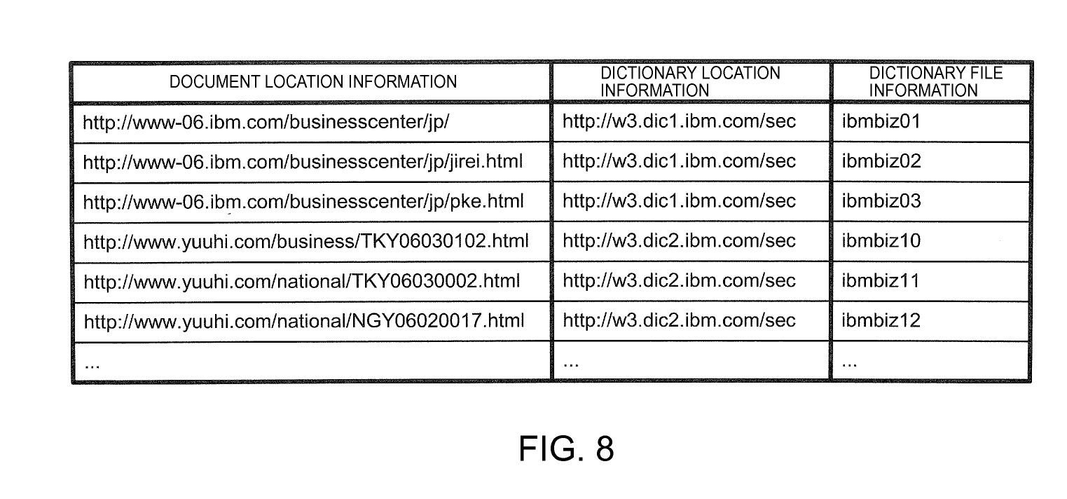

FIG. 8 is a view illustrating an example of the dictionary information.

As illustrated in FIG. 8, the dictionary information is information in which document location information, dictionary location information, and dictionary file information are associated with each other.

The document location information is information indicative of a location on a network where a disclosable document obtained by masking a confidential document is stored, and specifies a URI, for example.

As has been already described, the dictionary location information is information indicative of a location on a network where a dictionary file by which a masked portion of a disclosable document is replaced with a confidential element is stored.

As has been already described, the dictionary file information is information to specify a dictionary file at that location on the network which is indicated by the dictionary location information.

Subsequently, the following describes an operation of the authentication certificate server 20 in an embodiment in detail.

First explained is an operation of the authentication certificate server 20 at the time of registering a confidential document.

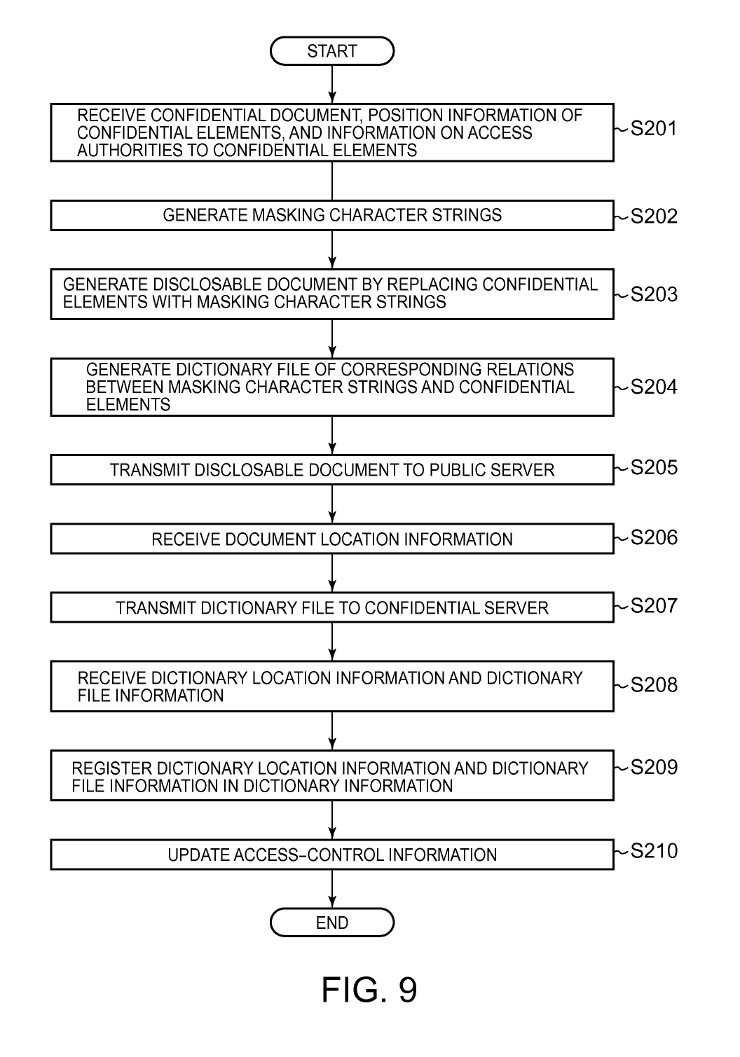

FIG. 9 is a flow chart illustrating an exemplary operation of the authentication certificate server 20 at this time.

When a user inputs, into the terminal device 10, a confidential document which the user wants to register, information indicative of positions of confidential elements in the confidential document, and information on access authorities of the confidential elements, the terminal device 10 transmits these pieces of information to the authentication certificate server 20, and the authentication certificate server 20 accordingly receives these pieces of information (S201). More specifically, in the authentication certificate server 20, the transfer section 21 receives these pieces of information. Note that the information on access authorities of confidential elements is, for example, information on whether or not a user having whichever of attributes can access this confidential element.

Subsequently, the authentication certificate server 20 generates as many masking character strings for masking confidential elements as the number of specified confidential elements (S202). Then, the authentication certificate server 20 generates a disclosable document by replacing the confidential elements in the confidential document with these masking character strings (S203), and generates a dictionary file which defines corresponding relations between the masking character strings and the confidential elements replaced with the masking character strings (S204). More specifically, in the authentication certificate server 20, the transfer section 21 transfers, to the document processing section 28, the received confidential document and information indicative of positions of the confidential elements in the confidential document. Subsequently, the document processing section 28 grasps the number of confidential elements based on the information indicative of positions of confidential elements transferred from the transfer section 21, and generates as many masking character strings as the number thus grasped. Then, the document processing section 28 generates a disclosable document and a dictionary file with the use of these masking character strings, and returns them to the transfer section 21.

Thereafter, in the authentication certificate server 20, the transfer section 21 transmits the disclosable document to the public server 30a (S205).

Hereby, the public server 30a receives and stores the disclosable document and sends document location information indicative of a stored location back to the authentication certificate server 20. Accordingly, in the authentication certificate server 20, the transfer section 21 receives this document location information (S206).

Further, in the authentication certificate server 20, the transfer section 21 transmits a dictionary file to the confidential server 30b (S207).

Hereby, the confidential server 30b receives and stores the dictionary file, and sends back, to the authentication certificate server 20, dictionary location information indicative of a stored location and dictionary file information to specify the dictionary file. Accordingly, in the authentication certificate server 20, the transfer section 21 receives these dictionary location information and dictionary file information (S208).

Subsequently, the authentication certificate server 20 registers the dictionary location information and dictionary file information in dictionary information (S209). More specifically, in the authentication certificate server 20, the transfer section 21 initially transfers the document location information, the dictionary location information, and the dictionary file information to the dictionary management section 26. Then, the dictionary management section 26 registers the document location information, the dictionary location information, and the dictionary file information thus transferred from the transfer section 21 in the dictionary information stored in dictionary information storage section 27.

Further, the authentication certificate server 20 updates access-control information (S210). More specifically, in the authentication certificate server 20, the transfer section 21 initially transfers the information on access authorities of confidential elements received in S201, the dictionary location information, and the dictionary file information to the access-control information management section 24. Subsequently, the access-control information management section 24 registers attribute information and accessibility information which are obtained from the information on access authorities of confidential elements transferred from the transfer section 21, the dictionary location information, and the dictionary file information in access-control information stored in the access-control information storage section 25.

The following describes an operation at the time of acquiring the confidential document thus separated and registered.

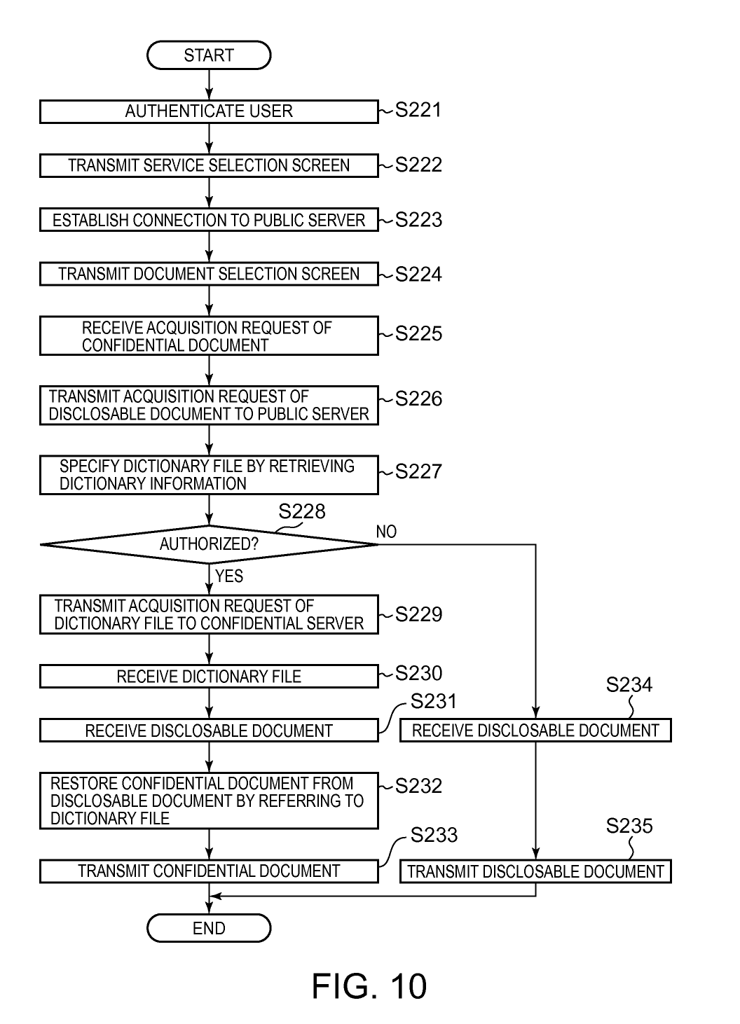

FIG. 10 is a flow chart illustrating an exemplary operation of the authentication certificate server 20 at this time.

When a user inputs a user ID and a password into the terminal device 10, the terminal device 10 transmits the user ID and the password to the authentication certificate server 20, and the authentication certificate server 20 accordingly authenticates the user based on the user ID and the password (S221). More specifically, the transfer section 21 initially receives the user ID and the password, and transfers them to the authentication section 22. Subsequently, the authentication section 22 judges whether or not this combination of the user ID and the password is registered in own-device authentication information stored in the authentication information storage section 23. If it is judged that the combination is registered, the authentication section 22 returns, to the transfer section 21, information indicating that the authentication has succeeded and attribute information associated with the user ID in the own-device authentication information. Then, the transfer section 21 holds the user ID and the attribute information as information of the user who is successfully authenticated.

Subsequently, in the authentication certificate server 20, the transfer section 21 transmits a screen (a service selection screen) for selecting a cloud service to the terminal device 10 (S222). Hereby, the service selection screen is displayed on the terminal device 10. Note that this service selection screen includes identification information of the public server 30a as an alternative.

Then, when the user selects the identification information of the public server 30a on the service selection screen, the terminal device 10 transmits the identification information of the public server 30a to the authentication certificate server 20, and the authentication certificate server 20 is accordingly connected to the public server 30a (S223). More specifically, the transfer section 21 initially receives the identification information of the public server 30a, and transfers it to the authentication section 22 together with the user ID held in S221. Subsequently, the authentication section 22 takes out a public-server user ID and a public-server password corresponding to the user ID from public-server authentication information stored in the authentication information storage section 23, and returns them to the transfer section 21. Accordingly, with the use of this public-server user ID and public-server password, the transfer section 21 is connected to the public server 30a, and receives a screen (a document selection screen) for selecting a document from the public server 30a.

Subsequently, in the authentication certificate server 20, the transfer section 21 transmits the document selection screen to the terminal device 10 (S224). Hereby, the document selection screen is displayed on the terminal device 10. Note that this document selection screen includes, as alternatives, pieces of document location information of disclosable documents which the user has stored in the public server 30a before.

Then, when the user specifies document location information of a disclosable document and requests acquisition of a confidential document corresponding to this disclosable document, the terminal device 10 transmits the acquisition request of this confidential document to the authentication certificate server 20, and in the authentication certificate server 20, the transfer section 21 receives the acquisition request of this confidential document (S225).

Hereby, in the authentication certificate server 20, the transfer section 21 initially specifies document location information of the disclosable document, and transmits the acquisition request of the disclosable document to the public server 30a (S226).

Further, the authentication certificate server 20 retrieves dictionary information so as to specify a dictionary file by which a masking character string in the disclosable document is replaced with a confidential element (S227). More specifically, the transfer section 21 initially transfers, to the dictionary management section 26, the document location information of the disclosable document included in that acquisition request of the confidential document which is received in S225. Subsequently, the dictionary management section 26 retrieves dictionary information stored in the dictionary information storage section 27 with the use of the document location information of the disclosable document as a key, so as to acquire dictionary location information and dictionary file information, and returns them to the transfer section 21. The transfer section 21 accordingly holds these dictionary location information and dictionary file information.

Then, the authentication certificate server 20 judges whether or not the user can access this dictionary file (S228). More specifically, the transfer section 21 initially transfers the attribute information held in S221 and the dictionary location information and the dictionary file information held in S227 to the access-control information management section 24. Subsequently, the access-control information management section 24 retrieves access-control information stored in the access-control information storage section 25 with the use of the attribute information, the dictionary location information, and the dictionary file information as keys, so as to acquire accessibility information, and returns them to the transfer section 21.

When it is judged that the user can access the dictionary file as a result thereof, that is, when the accessibility information returned from the access-control information management section 24 indicates that the user can access it, in the authentication certificate server 20, the transfer section 21 transmits an acquisition request of the dictionary file to the confidential server 30b (S229).

Hereby, the confidential server 30b transmits the dictionary file, and in the authentication certificate server 20, the transfer section 21 accordingly receives the dictionary file (S230).

In the meantime, in response to the acquisition request of the disclosable document which is transmitted in S226, the public server 30a transmits the disclosable document, and in the authentication certificate server 20, the transfer section 21 accordingly receives the disclosable document (S231).

Thereafter, the authentication certificate server 20 refers to the dictionary file received in S230, and replaces masking character strings in the disclosable document received in S231 with confidential elements so as to restore an original confidential document (S232). More specifically, the transfer section 21 initially transfers the dictionary file received in S230 and the disclosable document received in S231 to the document processing section 28. Then, the document processing section 28 generates a confidential document by replacing the masking character strings in the disclosable document with confidential elements according to definitions of the dictionary file, and returns it to the transfer section 21.

Subsequently, in the authentication certificate server 20, the transfer section 21 transmits this confidential document to the terminal device 10 (S233).

On the other hand, when it is judged that the user cannot access the dictionary file, that is, when the accessibility information returned from the access-control information management section 24 indicates that the user cannot access it, the authentication certificate server 20 does not transmit an acquisition request of the dictionary file, so that the dictionary file is never transmitted from the confidential server 30b. In response to the acquisition request of the disclosable document transmitted in S226, the public server 30a transmits the disclosable document, and in the authentication certificate server 20, the transfer section 21 accordingly receives the disclosable document (S234).

Subsequently, in the authentication certificate server 20, the transfer section 21 transmits this disclosable document to the terminal device 10 (S235).

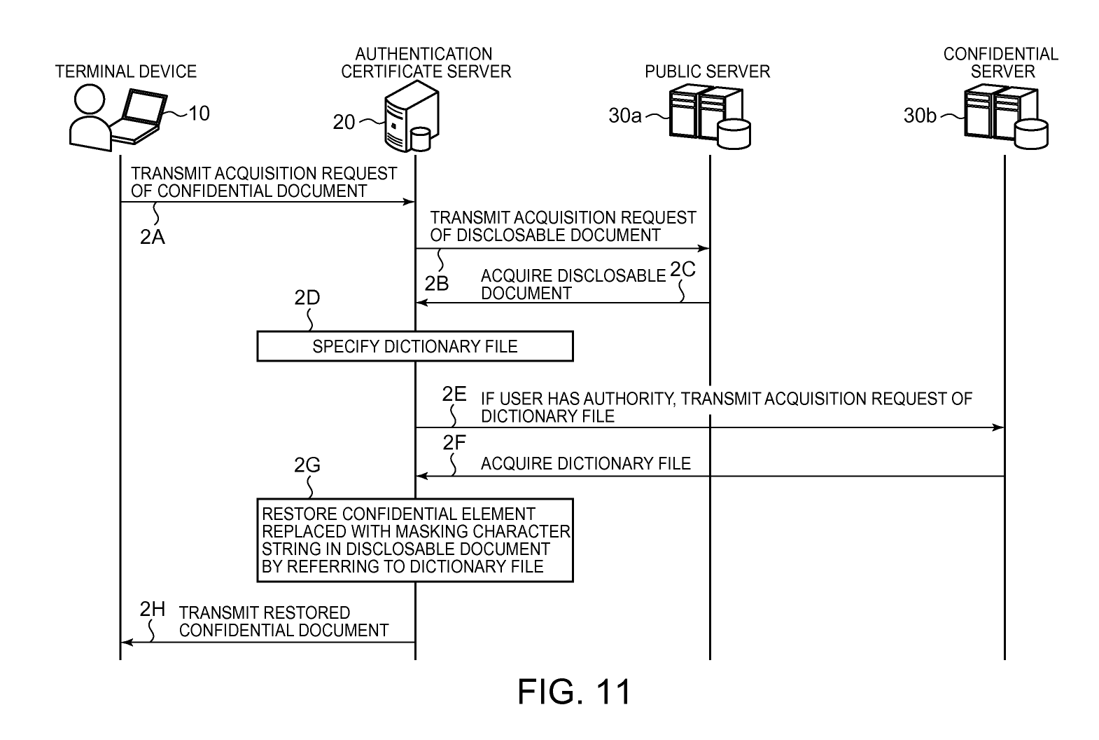

FIG. 11 is a sequence diagram illustrating exchanges of information between a terminal device 10, an authentication certificate server 20, a public server 30a, and a confidential server 30b in a case of specifying a confidential element corresponding to a disclosable document based on a description content of the disclosable document. Note that it is assumed that in advance of the exchanges of information in the figure, authentication of a user in the authentication certificate server 20 is completed.

Initially, when the user specifies, as a request URI, a URI of a disclosable document obtained by masking a confidential document and requests acquisition of the confidential document, the terminal device 10 transmits the acquisition request of the confidential document including the request URI to the authentication certificate server 20 (2A).

Subsequently, the authentication certificate server 20 checks on a request content, and transmits an acquisition request of the disclosable document to the public server 30a (2B).

Hereby, the public server 30a transmits the disclosable document, and the authentication certificate server 20 acquires this disclosable document (2C).

Then, the authentication certificate server 20 specifies a dictionary file based on description in the disclosable document received in 2C (2D). Here, a dictionary file is a file which defines which masked portion in a disclosable document should be replaced with which confidential element, and the dictionary file is stored in the confidential server 30b.

Further, the authentication certificate server 20 checks whether or not the user has an authority of access to this dictionary file, and if the user has the authority, the authentication certificate server 20 transmits an acquisition request of the dictionary file to the confidential server 30b (2E).

Hereby, the confidential server 30b transmits the dictionary file, and the authentication certificate server 20 acquires this dictionary file (2F).

Subsequently, the authentication certificate server 20 replaces a masked portion in the disclosable document acquired in 2C with a confidential element by referring to the dictionary file acquired in 2F so as to restore an original confidential document (2G).

Then, the authentication certificate server 20 transmits the original confidential document thus restored to the terminal device 10 (2H).

Hereinafter, an embodiment is described on the premise of such a sequence. However, the method to specify a dictionary file based on a request URI is attempted first, and if the dictionary file cannot be specified by this method, the method to specify a dictionary file based on the description in a received disclosable document may be attempted subsequently as described in an embodiment.

The following describes the configuration of the authentication certificate server 20 in an embodiment in detail.

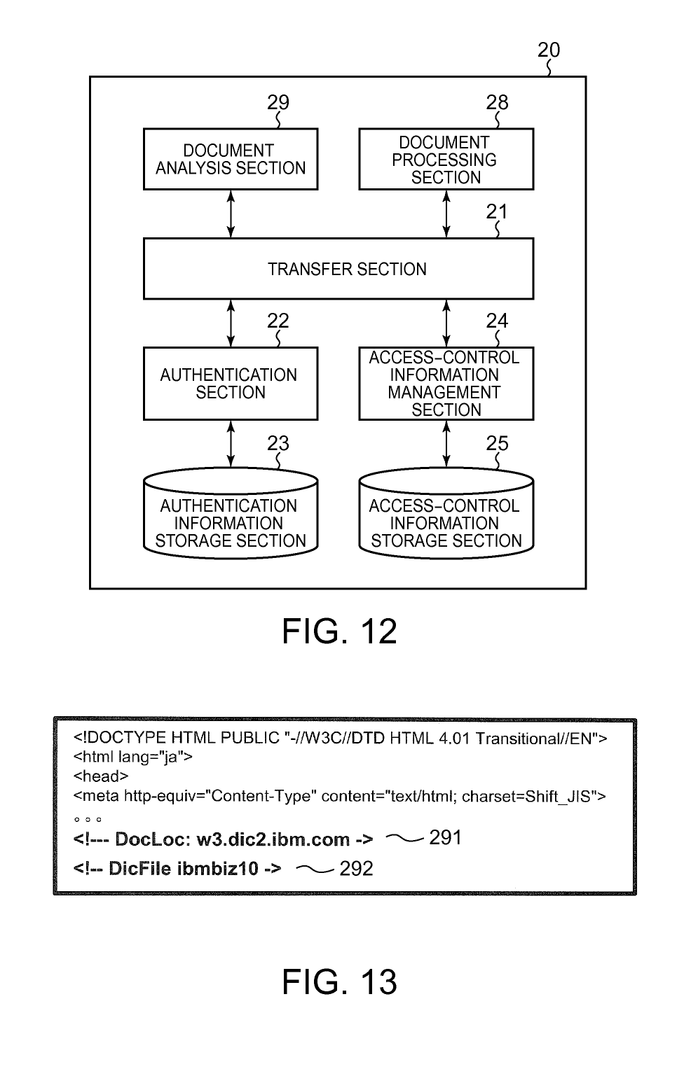

FIG. 12 is a block diagram illustrating an exemplary configuration of a function of the authentication certification server 20 in an embodiment.

As illustrated in the figure, the authentication certificate server 20 includes a transfer section 21, an authentication section 22, an authentication information storage section 23, an access-control information management section 24, an access-control information storage section 25, a document processing section 28, and a document analysis section 29.

The transfer section 21 provides information to the document analysis section 29 to execute the process. The authentication section 22, the authentication information storage section 23, the access-control information management section 24, the access-control information storage section 25, and the document processing section 28 are the same as those described above. Particularly, own-device authentication information, public-server authentication information, and confidential-server authentication information stored in the authentication information storage section 23 are the same as those illustrated in FIG. 6, and access-control information stored in the access-control information storage section 25 is the same as that illustrated in FIG. 7. Accordingly, the detailed explanations of these configurations are omitted.

In the meantime, in a case where the document analysis section 29 receives, from the transfer section 21, a disclosable document, dictionary location information and dictionary file information to specify a dictionary file by which a masking character string in a disclosable document is replaced with a confidential element, the document analysis section 29 describes the dictionary location information and dictionary file information in a predetermined form in the disclosable document. Further, in a case where the document analysis section 29 receives a disclosable document from the transfer section 21, the document analysis section 29 analyzes this disclosable document, and specifies a dictionary file to be used when a masking character strings in this disclosable document is replaced with a confidential element. Note that, the function of this document analysis section 29 may be implemented, for example, by executing an external program via the API. In an embodiment, the dictionary location information is used as an example of location information indicative of a second storage location. Further, the document analysis section 29 is provided as an example of a detecting section for detecting location information based on a content described in a processed document.

Here, a target disclosable document to be analyzed by the document analysis section 29 is explained.

FIG. 13 is a view illustrating an example of the disclosable document.

As illustrated in FIG. 13, a disclosable document includes a description 291 about dictionary location information and a description 292 about dictionary file information at the end, for example. The document analysis section 29 recognizes a dictionary file “ibmbiz10” placed at a location indicated by dictionary location information “w3.dic2.ibm.com” as a dictionary file to be referred to, based on these descriptions 291 and 292.

Subsequently, the following describes an operation of the authentication certificate server 20 in an embodiment in detail.

First explained is an operation of the authentication certificate server 20 at the time of registering a confidential document.

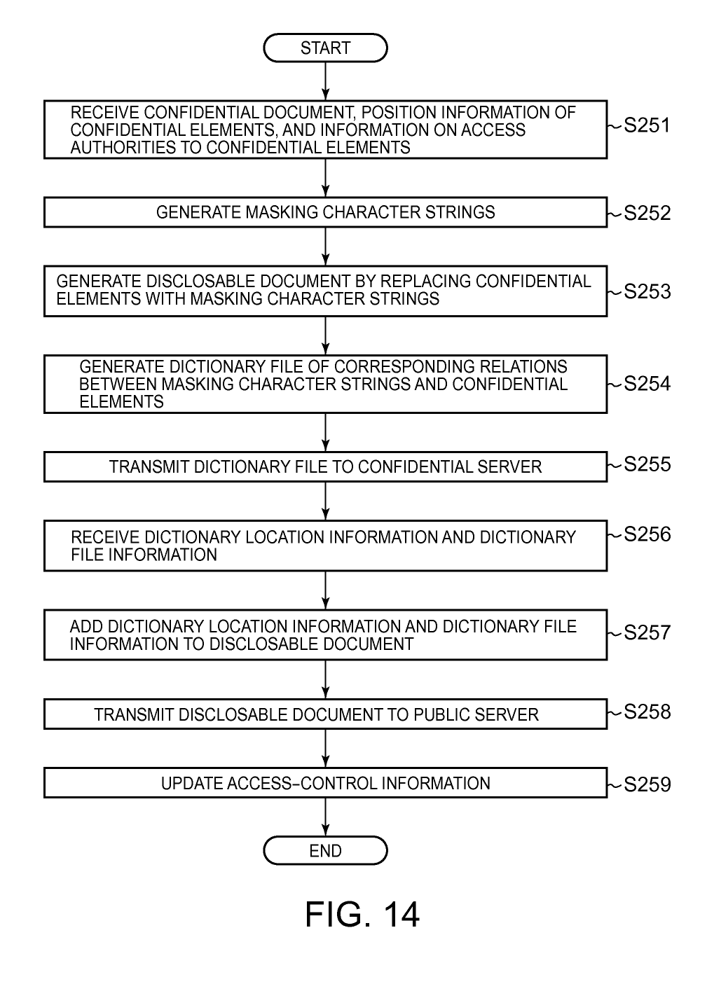

FIG. 14 is a flow chart illustrating an exemplary operation of the authentication certificate server 20 at this time.

In this flowchart, S251 to S254 are the same as S201 to S204 in FIGS. 9, and S255 and S256 are the same as S207 and S208 in FIG. 9. Therefore, detailed explanations thereof are omitted.

Upon receiving dictionary location information and dictionary file information in S256, the authentication certificate server 20 adds these dictionary location information and dictionary file information to a disclosable document (S257). More specifically, in the authentication certificate server 20, the transfer section 21 initially transfers a disclosable document, dictionary location information, and dictionary file information to the document analysis section 29. Then, the document analysis section 29 adds the dictionary location information and dictionary file information transferred from the transfer section 21 to the disclosable document transferred from the transfer section 21, and returns them to the transfer section 21.

Thereafter, in the authentication certificate server 20, the transfer section 21 transmits the disclosable document to the public server 30a (S258).

Further, the authentication certificate server 20 updates access-control information (S259). More specifically, in the authentication certificate server 20, the transfer section 21 initially transfers information on access authorities of confidential elements received in S251, dictionary location information, and dictionary file information to the access-control information management section 24. Subsequently, the access-control information management section 24 registers attribute information and accessibility information which are obtained from the information on access authorities of confidential elements transferred from the transfer section 21, the dictionary location information, and the dictionary file information to access-control information stored in the access-control information storage section 25.

The following describes an operation at the time of acquiring the confidential document thus separated and registered.

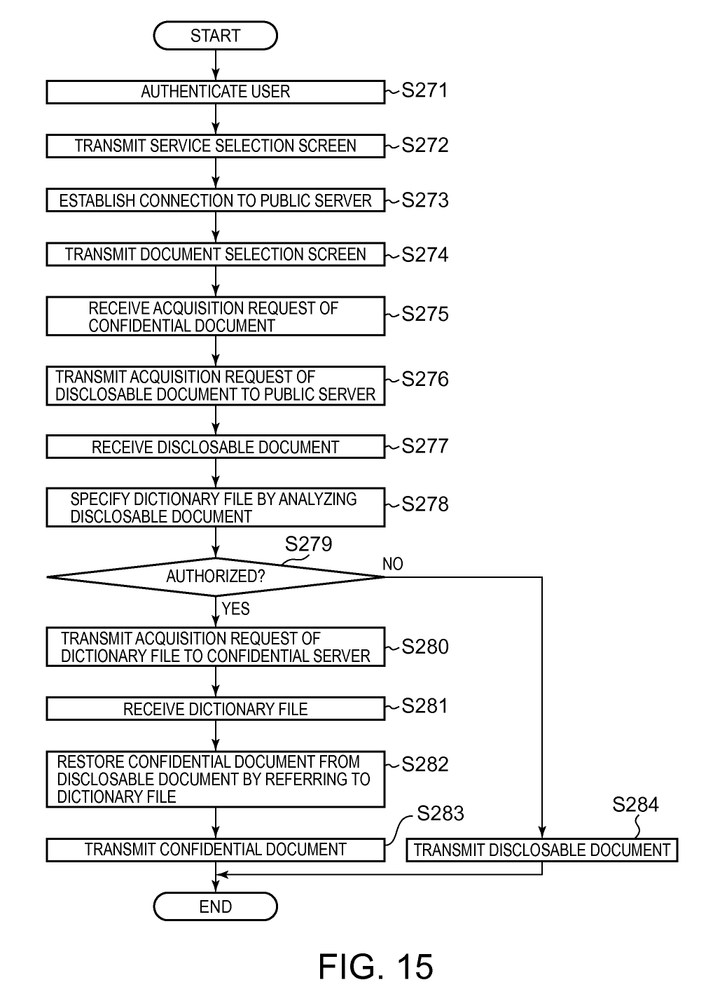

FIG. 15 is a flow chart illustrating an exemplary operation of the authentication certificate server 20 at this time.

In this flowchart, S271 to S276 are the same as S221 to S226 in FIG. 10, and therefore detailed explanations thereof are omitted.

When an acquisition request of the disclosable document is transmitted in S276, the public server 30a transmits the disclosable document in response to this, and in the authentication certificate server 20, the transfer section 21 accordingly receives the disclosable document (S277).

Hereby, the authentication certificate server 20 analyzes the disclosable document so as to specify a dictionary file by which a masking character string in the disclosable document is replaced with a confidential element (S278). More specifically, the transfer section 21 initially transfers the disclosable document received in S277 to the document analysis section 29. Then, the document analysis section 29 analyzes whether or not a description in a predetermined form is made at a predetermined position in the disclosable document so as to acquire dictionary location information and dictionary file information, and returns them to the transfer section 21. The transfer section 21 accordingly holds these dictionary location information and dictionary file information.

Then, the authentication certificate server 20 judges whether or not the user can access this dictionary file (S279). More specifically, the transfer section 21 initially transfers attribute information held in S271 and the dictionary location information and the dictionary file information held in S278 to the access-control information management section 24. Subsequently, the access-control information management section 24 retrieves access-control information stored in the access-control information storage section 25 with the use of the attribute information, the dictionary location information, and the dictionary file information as keys, so as to acquire accessibility information, and returns it to the transfer section 21.

S280, S281, S282, and S283 in a case where it is judged that the user can access the dictionary file as a result thereof are the same as S229, S230, S232, and S233 in FIG. 10, and therefore detailed explanations thereof are omitted. Note that a target disclosable document to be processed in S282 is a disclosable document received in S277, which is different from the case of S232 in FIG. 10.

In the meantime, S284 in a case where it is judged that the user cannot access the dictionary file is the same as S235 in FIG. 10, and therefore a detailed explanation thereof is omitted. Note that a target disclosable document to be processed in S284 is a disclosable document received in S277, which is different from the case of S235 in FIG. 10.

Note that in an embodiment, it is assumed that confidential elements are included in a dictionary file and are stored in the confidential server 30b, but how to store confidential elements is not limited to this. For example, confidential elements may be stored in the confidential server 30b with identification information attached thereto without including them in a dictionary file, and information indicative of which masking character string should be replaced with a confidential element with which identification information may be stored in another location.

Further, in an embodiment, confidential elements are removed from a confidential document by replacing the confidential elements with masking character strings, but it is not necessarily required to replace confidential elements with masking character strings. For example, confidential elements are removed from a confidential document, and a dictionary file which defines to which positions in the confidential document the confidential elements should be returned may be managed.

Thus, in an embodiment, even if a disclosable document which is generated by removing confidential elements constituting part of a confidential document from the confidential document are stored separately from the confidential elements thus removed, the confidential document can be restored by managing which confidential element should be returned to which position in the disclosable document.

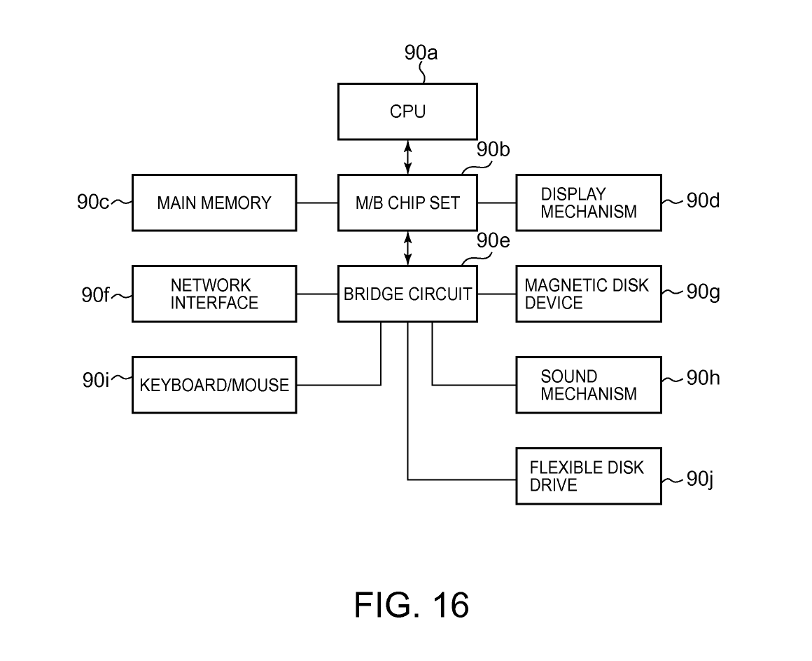

Finally, a hardware configuration of a computer that can be applied to embodiment(s) is described. FIG. 16 is a view illustrating an example of such hardware configuration of a computer. As illustrated in FIG. 16, the computer includes: a CPU (Central Processing Unit) 90a, which is computing device; a main memory 90c which is connected to the CPU 90a via an M/B (motherboard) chip set 90b; and a display mechanism 90d which is also connected to the CPU 90a via the M/B chip set 90b. Further, to the M/B chip set 90b, a network interface 90f, a magnetic disk device (HDD) 90g, a sound mechanism 90h, a keyboard/mouse 90i, and a flexible disk drive 90j are connected via a bridge circuit 90e.

Note that, in FIG. 16, these constituents are connected to each other via buses. For example, the CPU 90a and the M/B chip set 90b, and the M/B chip set 90b and the main memory 90c are connected via respective CPU buses. Further, the M/B chip set 90b and the display mechanism 90d may be connected via an AGP (Accelerated Graphics Port), but when the display mechanism 90d includes a video card that supports PCI Express, the M/B chip set 90b and this video card are connected via a PCI Express (PCIe) bus. Moreover, for connection to the bridge circuit 90e, PCI Express can be used, for example, for the network interface 90f. Further, for the magnetic disk device 90g, serial ATA (AT Attachment), ATA of parallel transfer, or PCI (Peripheral Components Interconnect) can be used, for example. Furthermore, for the keyboard/mouse 90i and the flexible disk drive 90j, USB (Universal Serial Bus) can be used.

Here, the present invention may be realized fully by hardware or fully by software. Further, the present invention can be realized by both hardware and software. Furthermore, the present invention can be realized as a computer, a data-processing system, or a computer program. This computer program can be provided in such a manner that it is stored in a computer-readable storage medium. Here, conceivable examples of the medium include electronic, magnetic, optical, electromagnetic, infrared, or semiconductor system (apparatus or device), or a propagation medium. Further, examples of the computer-readable medium include a semiconductor, a solid state storage device, a magnetic tape, a removable computer diskette, a random-access memory (RAM), a read-only memory (ROM), a rigid magnetic disk, and an optical disk. Current examples of the optical disk include a compact disk read-only memory (CD-ROM), compact disk read/write (CD-R/W), and a DVD.

The present invention is described with the use of the embodiment as above, but the technical scope of the present invention is not limited to the above embodiment. It will be apparent to a person skilled in the art that various modifications may be made to the embodiments of the present invention or alternative embodiments may be employed without departing from the spirit and scope of the present invention.

1. An apparatus for processing a processed document obtained by performing, on an original document, removal of an information element constituting part of the original document, the apparatus comprising:
a first acquisition section for acquiring the processed document from a first storage in which the processed document is stored;
a second acquisition section for acquiring the information element from a second storage in which the information element is stored; and
a restoration section for restoring the original document by adding the information element acquired by the second acquisition section to a position which is predefined as a position where the information element is to be added in the processed document acquired by the first acquisition section.

2. The apparatus according to claim 1, wherein:
in a case where the processing is to replace the information element with a dummy element for covering a meaning of the information element, the restoration section uses a position of the dummy element in the processed document which is to be replaced with the information element, as a position where the information element is to be added in the processed document.

3. The apparatus according to claim 1, wherein:
the second acquisition section acquires the information element by acquiring definition information which defines a position where the information element is to be added in the processed document, from the second storage in which the information element is stored in such a manner that the information element is included in the definition information.

4. The apparatus according to claim 1, wherein:
the second acquisition section acquires the information element from a storing location which is associated with a storing location of the processed document beforehand.

5. The apparatus according to claim 1, wherein:
the second acquisition section acquires the information element from a storing location described in the processed document acquired by the first acquisition section.

6. The apparatus according to claim 1, wherein:
the second acquisition section acquires the information element in a case where information indicating that a user who requests the restoration of the original document is allowed to use the information element is registered.

7. The apparatus according to claim 1, further comprising:
a receiving section for receiving the original document and position information indicative of a position of the information element in the original document;
a processing section for performing, on the original document received by the receiving section, removal of the information element at a position indicated by the position information received by the receiving section; and
a transmitting section for transmitting the processed document generated by the processing section to the first storage and for transmitting the information element thus removed by the processing by the processing section to the second storage.

8. An apparatus for processing a processed document obtained by performing, on an original document, replacement of a confidential element constituting part of the original document with a dummy element that reduces confidentiality of the confidential element, the apparatus comprising:
a first acquisition section for acquiring the processed document from a first storage in which the processed document is stored;
a detecting section for detecting, based on first location information indicative of a location of the first storage, second location information indicative of a location of a second storage in which definition information is stored which defines a position of the dummy element to be replaced with the confidential element when the original document is restored;
a second acquisition section for acquiring the definition information from the second storage placed at the location indicated by the second location information detected by the detecting section; and
a restoration section for restoring the original document by replacing with the confidential element the dummy element in the processed document acquired by the first acquisition section, which dummy element is placed at the position defined by the definition information acquired by the second acquisition section.

9. An apparatus for processing a processed document obtained by performing, on an original document, replacement of a confidential element constituting part of the original document with a dummy element that reduces confidentiality of the confidential element, the apparatus comprising:
a first acquisition section for acquiring the processed document from a first storage in which the processed document is stored;
a detecting section for detecting, based on a content described in the processed document acquired by the first acquisition section, location information indicative of a location of a second storage in which definition information is stored which defines a position of the dummy element to be replaced with the confidential element when the original document is restored;
a second acquisition section for acquiring the definition information from the second storage placed at the location indicated by the location information detected by the detecting section; and
a restoration section for restoring the original document by replacing with the confidential element the dummy element in the processed document acquired by the first acquisition section, which dummy element is placed at the position defined by the definition information acquired by the second acquisition section.

10. A method for processing a processed document obtained by performing, on an original document, removal of an information element constituting part of the original document, the method comprising:
acquiring the processed document from a first storage in which the processed document is stored;
acquiring the information element from a second storage in which the information element is stored; and
restoring the original document by adding the information element thus acquired to a position which is predefined as a position where the information element is to be added in the processed document thus acquired.

11. The method according to claim 10, wherein:
in a case where the processing is to replace the information element with a dummy element for covering a meaning of the information element, the restoring uses a position of the dummy element in the processed document which is to be replaced with the information element, as a position where the information element is to be added in the processed document.

12. The method according to claim 10, wherein:
the acquiring the information element acquires the information element by acquiring definition information which defines a position where the information element is to be added in the processed document, from the second storage in which the information element is stored in such a manner that the information element is included in the definition information.

13. The method according to claim 10, wherein:
the acquiring the information element acquires the information element from a storing location which is associated with a storing location of the processed document beforehand.

14. The method according to claim 10, wherein:
the acquiring the information element acquires the information element from a storing location described in the processed document acquired from the first storage.

15. The method according to claim 10, wherein:
the acquiring the information element acquires the information element in a case where information indicating that a user who requests the restoration of the original document is allowed to use the information element is registered.

16. The method according to claim 10, further comprising:
receiving the original document and position information indicative of a position of the information element in the original document;
performing, on the received original document, removal of the information element at a position indicated by the position information; and
transmitting the processed document to the first storage and transmitting the information element thus removed to the second storage.

17. A program stored on a computer-readable storage medium for performing a method for processing a processed document obtained by performing, on an original document, removal of an information element constituting part of the original document, when the program is executed by a computer device, the method comprising:
acquiring the processed document from a first storage in which the processed document is stored;
acquiring the information element from a second storage in which the information element is stored; and
restoring the original document by adding the information element thus acquired to a position which is predefined as a position where the information element is to be added in the processed document thus acquired.
